(19) United States
(12) Patent Application Publication
(10) Pub. No.: US 2006/0145473 A1
(43) Pub. Date: Jul. 6, 2006

(54) Hose coupling

(76) Inventor: Wen Kuei Hwang, Taichung (TW)

Correspondence Address: Wen Kuei Hwang, P.O. Box 63-298, Taichung, 40699, TW

(21) Appl. No.: 11/025,753

(22) Filed: Dec. 30, 2004

(51) Int. Cl. F16L 33/00

(52) U.S. Cl. 285/249

(57) ABSTRACT

A hose coupling includes a connector having one or more ports each having an enlarged outer duct and an inclined segment disposed between the duct and the port. One or more gaskets are disposed in the port and engaged with an inclined surface of the duct, a ferrule includes a threaded end for threading with the duct, and for forcing the gasket between the connector and the ferrule and the hose. The ferrule includes an inclined surface, a sleeve is disposed in the ferrule, and engaged between the gasket and the ferrule, and includes a number of orifices to receive spherical members which are engaged between the inclined surface of the ferrule and the hose, to solidly secure the ferrule and the hose together.

### BACKGROUND OF THE INVENTION

1. Field of the Invention

The present invention relates to a hose coupling, and more particularly to a hose coupling having a quick and flexible coupling structure.

2.Description of the Prior Art

Various kinds of typical hose couplings have been developed and comprise a connector for coupling two or more pipes or hoses together.

For example, U.S. Pat. No. 3,915,478 to Al et al. discloses one of the typical corrosion resistant pipe joints including a sleeve having a neckdown portion and an annular resilient gasket for engaging with a pipe end, and for attaching or securing the pipe end to the sleeve. Normally, a lock nut is further provided and threaded to the sleeve, to solidly secure and couple the pipe to the sleeve. However, the lock nut should be firmly threaded and attached to the sleeve, otherwise, the pipe may not be solidly secured and coupled to the sleeve.

U.S. Pat. No. 4,664,424 to Smith discloses another typical hose couplings including an insert and a ferrule each having annular ribs extended therefrom for engaging with wire reinforced pressure hose, and thus for solidly attaching or securing the hose to the insert. However, similarly, the ferrule should also be firmly threaded and attached to the insert, otherwise, the hose may not be solidly secured and coupled to the insert.

U.S. Pat. No. 5,037,143 to Sanders et al. discloses a further typical hose construction including a tubular body member having an inner sleeve extended therefrom, and having a number of outwardly blunt projections extended from the inner sleeve, for engaging with hoses, and for coupling to the hoses with an outer sleeve. However, the hoses may not be solidly coupled or secured to the inner sleeve, and may have a good chance to be disengaged from the inner sleeve.

The present invention has arisen to mitigate and/or obviate the afore-described disadvantages of the conventional hose coupling devices.

### SUMMARY OF THE INVENTION

The primary objective of the present invention is to provide a hose coupling including a quick and flexible coupling structure for allowing pipes or hoses to be easily and readily and quickly coupled together.

In accordance with one aspect of the invention, there is provided a hose coupling comprising a connector including a first port having an enlarged outer duct provided thereon, the duct including an outer diameter greater than that of the first port, and an inclined segment provided between the duct and the first port, to form an inclined surface in the first port, and an inner thread provided in the duct, at least one gasket disposed in the first port and engaged with the inclined surface of the duct of the first port, a ferrule including a threaded end formed thereon, for threading with the inner thread of the duct of the connector, and for threadedly securing the ferrule to the first port of the connector, the ferrule being engageable with the gasket, to force the gasket between the connector and the ferrule and the hose, to make a water tight seal between the connector and the ferrule and the hose, the ferrule including a bore formed therein and including an inclined surface formed therein, a hose engageable into the bore of the ferrule, a sleeve disposed and received in the bore of the ferrule, and including a first end engaged with the inclined surface of the ferrule, and including a second end engaged with the gasket, the sleeve including a plurality of orifices formed therein, and a plurality of spherical members disposed in the orifices of the sleeve, and engaged with the inclined surface of the ferrule, and also engaged with the hose, to solidly secure and couple the ferrule and the hose together.

A second gasket may further be provided and disposed in the first port and engaged between the gasket and the ferrule. The second gasket included a peripheral flange extended therefrom and having an outer diameter smaller than that of the second gasket, to form an annular shoulder therein, and to receive the threaded end of the ferrule.

The connector further includes at least one second port provided thereon, at least one second gasket disposed in the first port and engaged with the inclined surface of the duct of the first port, a ferrule having a threaded end for threading with the second port of the connector, the ferrule is engageable with the second gasket, to force the gasket between the connector and the ferrule and the hose, a hose is engageable into the ferrule, a sleeve is disposed and received in the ferrule and engaged between the second gasket and the ferrule, and includes a plurality of orifices formed therein, and a plurality of spherical members disposed in the orifices of the sleeve, and engaged between the ferrule and the hose.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a hose coupling in accordance with the present invention;

FIG. 2 is an enlarged partial plan view of the hose coupling, in which one half of the hose coupling is cut off to show an inner structure of the hose coupling;

FIG. 3 is an exploded view similar to FIG. 1, illustrating the other arrangement of the hose coupling;

FIG. 4 is an enlarged partial plan view of the hose coupling as shown in FIG. 3, in which one half of the hose coupling is also cut off to show an inner structure of the hose coupling;

FIG. 5 is an exploded view similar to FIGS. 1 and 3, illustrating another arrangement of the hose coupling;

FIG. 6 is an exploded view similar to FIGS. 1, 3 and 5, illustrating a further arrangement of the hose coupling; and

FIG. 7 is an exploded view similar to FIGS. 1, 3, 5, and 6, illustrating a still further arrangement of the hose coupling.

### DETAILED DESCRIPTION OF THE PREFERRED EMBODIMENT

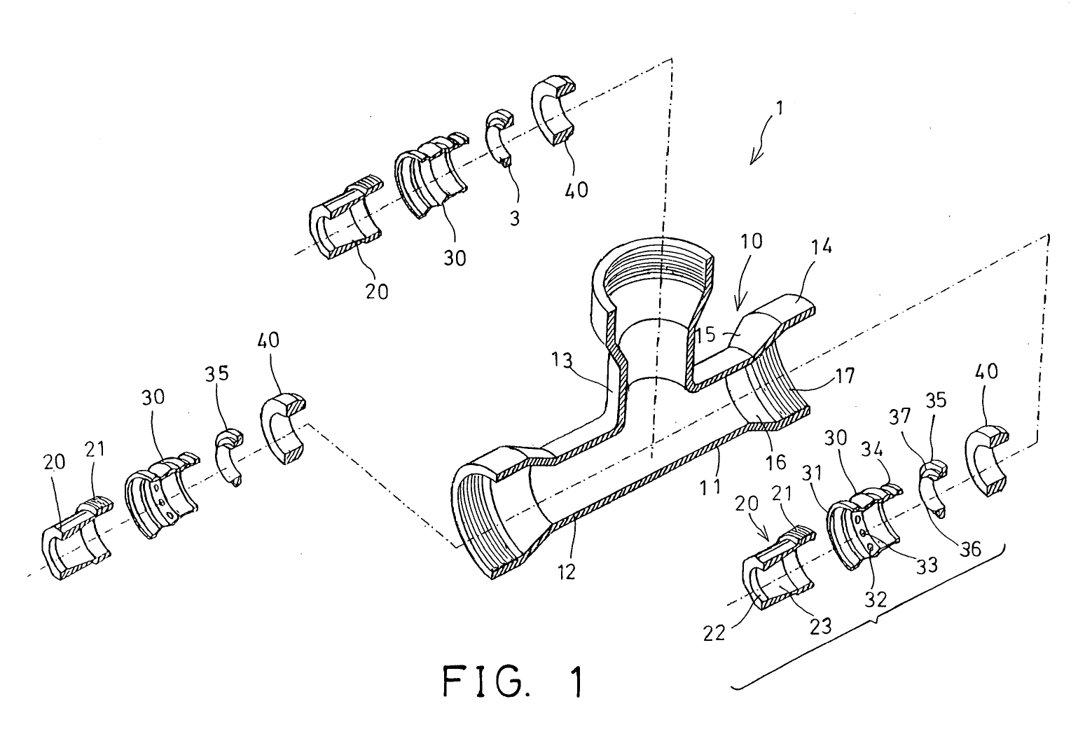

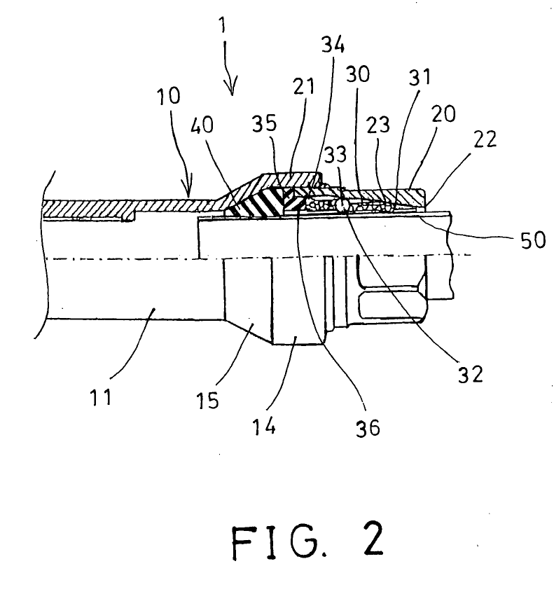

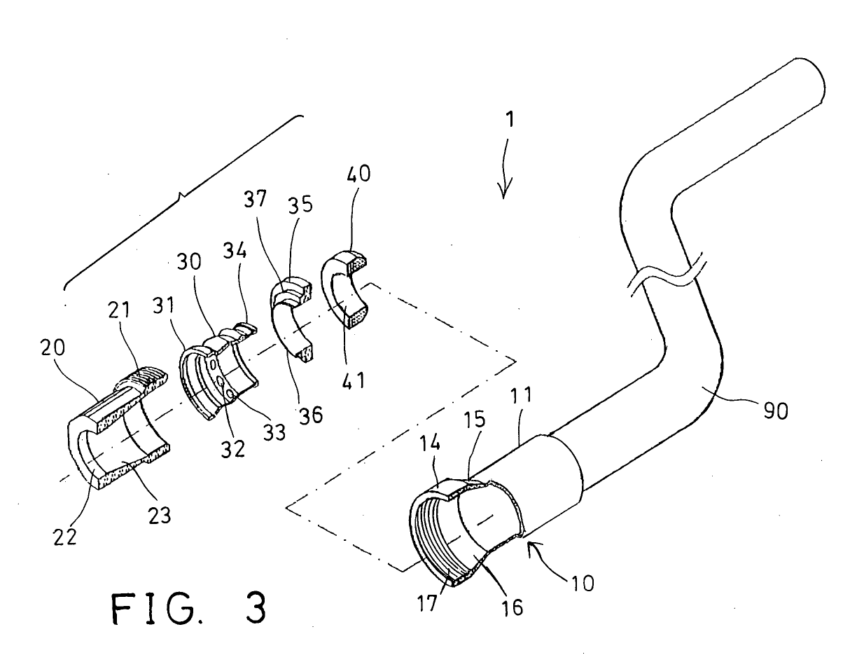

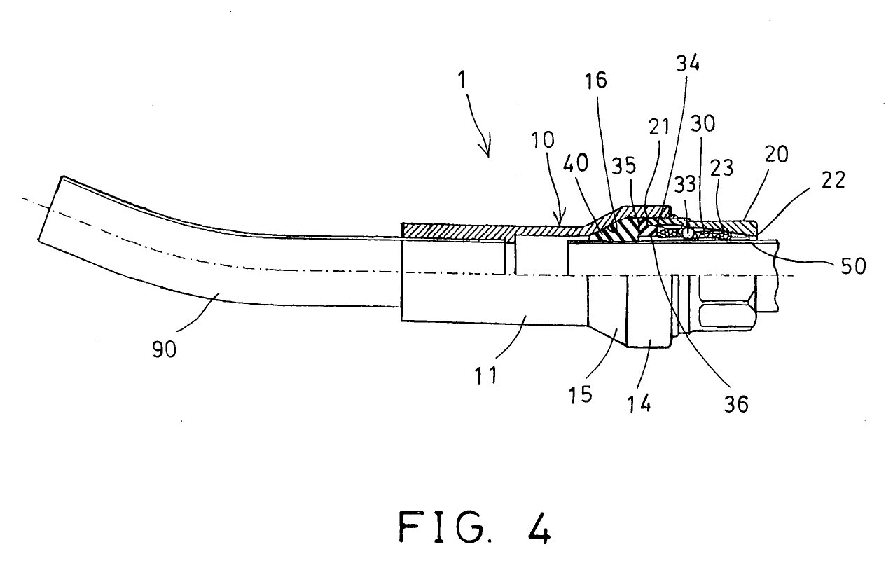

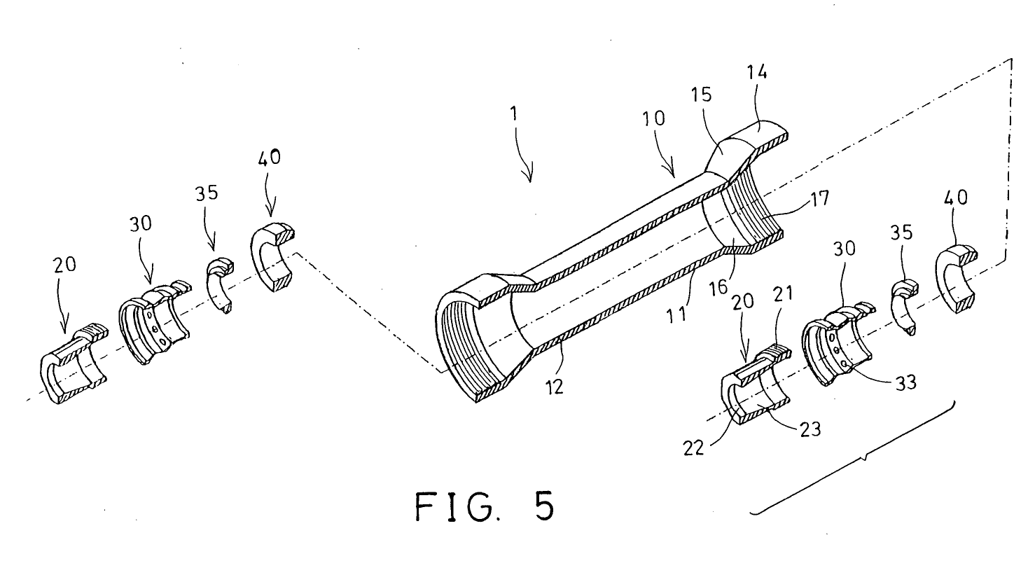

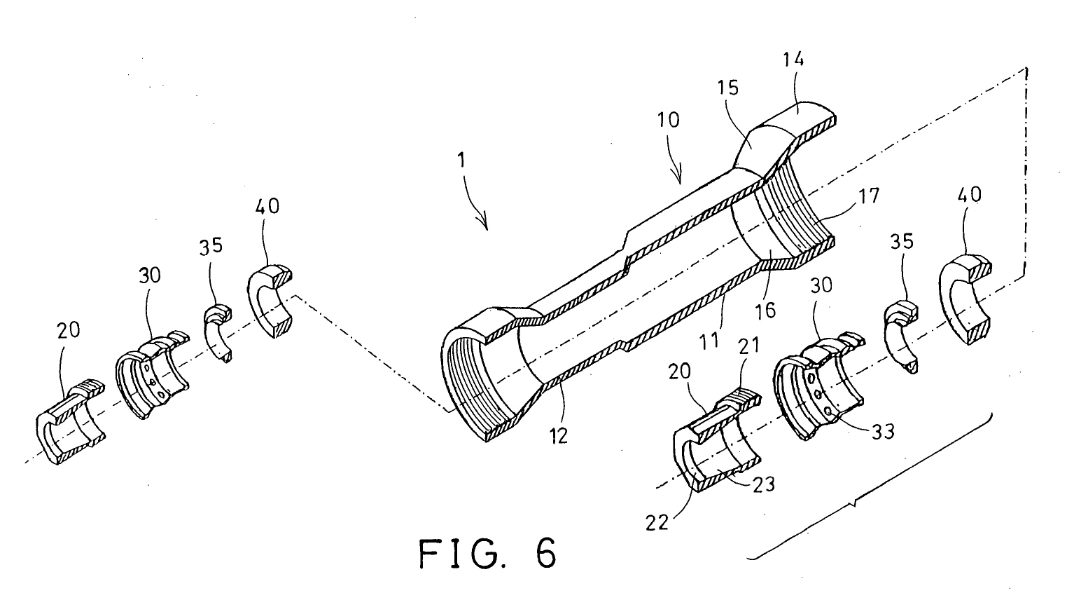

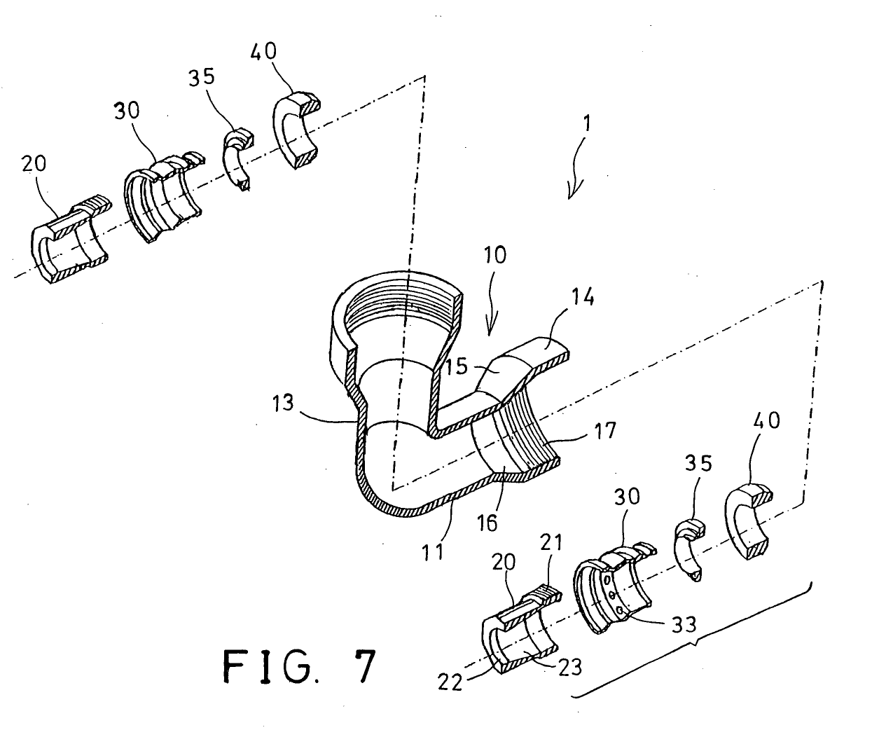

Referring to the drawings, and initially to FIGS. 1 and 2, a hose coupling 1 in accordance with the present invention comprises a connector 10 including one or more ports 11, 12, 13 provided or formed therein, such as including a T-shape having three ports 11, 12, 13 (FIG. 1) provided therein, an I-shape having two ports 11, 12 (FIGS. 5, 6) provided therein, an L-shape having two ports 11, 13 (FIG. 7) provided therein, or including an I-shape having one port 11 (FIG. 3) provided therein and having a pipe 90 coupled thereto (FIGS. 3, 4).

The connector 10 includes an enlarged duct 14 formed or provided on an outer portion of each of the ports 11, 12, 13, and having an outer diameter greater than that of the ports 11, 12, 13 respectively, and having an inclined segment 15 formed or provided between the duct 14 and the ports 11, 12, 13 respectively, in order to form or define an inclined or conical surface 16 in such as the inclined segment 15, and to provide an inner thread 17 within the duct 14.

The connector 10 further includes a ferrule 20 having an outer thread 21 formed or provided on one end thereof, for threading with the inner thread 17 of the duct 14 of the connector 10, and thus for threadedly or adjustably securing the ferrule 20 to either of the ports 11, 12, 13 of the connector 10 (FIGS. 2, 4). The ferrule 20 includes a bore 22 formed therein for receiving a hose 50 that is to be coupled to the connector 10, in which the hose 50 may also be extended or engaged into the connector 10 (FIGS. 2, 4). The ferrule 20 further includes an inclined surface 23 formed therein.

The connector 10 further includes a resilient or flexible or soft sleeve 30 disposed or received in the bore 22 of the ferrule 20, and having one end 31 engaged with the inclined surface 23 of the ferrule 20, and having a number of orifices 32 formed therein, such as formed in the middle portion thereof, for receiving balls or spherical members 33 therein, in which the balls or spherical members 33 may also be engaged with the inclined surface 23 of the ferrule 20 (FIGS. 2, 4). The resilient sleeve 30 includes another end 34 located within the one end of the ferrule 20 having the outer thread 21 formed therein.

The connector 10 further includes a resilient or flexible or soft gasket 40 disposed or received in the port 11 and engaged with the inclined surface 16 of the duct 14 or of the port 11, and another resilient or flexible or soft gasket 35 disposed or received in the port 11 and engaged between the gasket 40 and the other end 34 of the sleeve 30. It is preferable that the gasket 35 includes a reduced annular or peripheral flange 36 extended therefrom and having an outer diameter smaller than that of the gasket 35, to form or define an annular or peripheral shoulder 37 therein, and to receive or to seat the threaded end 21 of the ferrule 20.

In operation, as shown in FIG. 2, the gaskets 35, 40 may be disposed or received in the port 11 of the connector 10, and may be engaged with the inclined surface 16 of the duct 14 or of the port 11. The threaded end or the outer thread 21 of the ferrule 20 may then be threaded with the inner thread 17 of the duct 14 of the connector 10, and may solidly force or squeeze the gaskets 35, 40 between the ferrule 20 and the connector 10 and the hose 50, in order to make a water tight seal between the port 11 of the connector 10 and the hose 50.

In addition, the balls or spherical members 33 may also be engaged between the ferrule 20 and the hose 50, and may also be engaged with the inclined surface 23 of the ferrule 20 (FIGS. 2, 4), such that the balls or spherical members 33 may be biased and engaged between the inclined surface 23 of the ferrule 20 and the hose 50, and may thus be used to anchor or to secure or to latch the ferrule 20 and the hose 50 together. It is to be noted that the balls or spherical members 33 may further be solidly engaged between the ferrule 20 and the hose 50 due to the inclined surface 23 of the ferrule 20, when the ferrule 20 is further rotated or threaded with the duct 14 of the connector 10.

Similarly, the other ports 12, 13 of the connector 10 each may also include two gaskets 35, 40 disposed or received in the port 11 of the connector 10, and a sleeve 30 engaged onto a hose 50, and a ferrule 20 also engaged onto the hose 50 and engaged onto the sleeve 30, and then threaded with the port 11, to solidly couple and secure the hose 50 to the port 11 of the connector 10.

Accordingly, the hose coupling in accordance with the present invention includes a quick and flexible coupling structure for allowing pipes or hoses to be easily and readily and quickly coupled together.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A hose coupling comprising:
a connector including a first port having an enlarged outer duct provided thereon, said duct including an outer diameter greater than that of said first port, and an inclined segment provided between said duct and said first port, to form an inclined surface in said first port, and an inner thread provided in said duct,
at least one gasket disposed in said first port and engaged with said inclined surface of said duct of said first port,
a ferrule including a threaded end formed thereon, for threading with said inner thread of said duct of said connector, and for threadedly securing said ferrule to said first port of said connector, said ferrule being engageable with said at least one gasket, to force said at least one gasket between said connector and said ferrule and said hose, to make a water tight seal between said connector and said ferrule and said hose, said ferrule including a bore formed therein and including an inclined surface formed therein,
a hose engageable into said bore of said ferrule,
a sleeve disposed and received in said bore of said ferrule, and including a first end engaged with said inclined surface of said ferrule, and including a second end engaged with said at least one gasket, said sleeve including a plurality of orifices formed therein, and
a plurality of spherical members disposed in said orifices of said sleeve, and engaged with said inclined surface of said ferrule, and also engaged with said hose, to solidly secure and couple said ferrule and said hose together.

2. The hose coupling as claimed in claim 1 further comprising a second gasket disposed in said first port and engaged between said at least one gasket and said ferrule.

3. The hose coupling as claimed in claim 2, wherein said second gasket included a peripheral flange extended therefrom and having an outer diameter smaller than that of said second gasket, to form an annular shoulder therein, and to receive said threaded end of said ferrule.

4. The hose coupling as claimed in claim 1, wherein said connector further includes at least one second port provided thereon, at least one second gasket disposed in said first port and engaged with said inclined surface of said duct of said first port, a ferrule having a threaded end for threading with said at least one second port of said connector, said ferrule is engageable with said at least one second gasket, to force said at least one gasket between said connector and said ferrule and said hose, a hose is engageable into said ferrule, a sleeve is disposed and received in said ferrule and engaged between said at least one second gasket and said ferrule, and includes a plurality of orifices formed therein, and a plurality of spherical members disposed in said orifices of said sleeve, and engaged between said ferrule and said hose.
